(19) United States
(12) Patent Application Publication
(10) Pub. No.: US 2019/0277645 A1
(43) Pub. Date: Sep. 12, 2019

(54) NAVIGATION ROUTE EDITING METHOD AND APPARATUS, AND CONTROL DEVICE

(71) Applicant: SZ DJI TECHNOLOGY CO., LTD., Shenzhen (CN)

(72) Inventors: Zefei LI, Shenzhen (CN); Chuantang XIONG, Shenzhen (CN); Zhiqiang WU, Shenzhen (CN)

(21) Appl. No.: 16/422,595

(22) Filed: May 24, 2019

Related U.S. Application Data
(63) Continuation of application No. PCT/CN2016/107512, filed on Nov. 28, 2016.

(51) Int. Cl. G01C 21/34; G06F 3/0484; G01C 21/20

(52) U.S. Cl. CPC G01C 21/3461; G01C 21/20; G06F 3/04845

(57) ABSTRACT

A navigation route editing method includes, when a new corner point is added, determining one of initial corner points of an initial area as a connecting corner point based on locations of the initial corner points and a location of the new corner point. The new corner point and the connecting corner point form end points of a to-be-analyzed line section, and the initial area includes boundary line sections each having two adjacent ones of the initial corner points as end points. The method further includes determining whether one of the boundary line sections has an intersecting relationship with the to-be-analyzed line section, and, if not, determining a target area including the new corner point and the initial corner points. The method also includes planning a navigation route in the target area.

### CROSS-REFERENCE TO RELATED APPLICATION

This application is a continuation of International Application No. PCT/CN2016/107512, filed on Nov. 28, 2016, the entire content of which is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates to control technologies and, more particularly, to a navigation route editing method, a navigation route editing apparatus, and a control device.

### BACKGROUND

Navigation routes include flight routes for aerial vehicles and movement routes for ground movable objects such as automatic automobile. A user may specify a plurality of location points by marking in a map displayed on a certain interface, and may sequentially connect the plurality of location points in the map to obtain a navigation route. The location points are called waypoints. When an unmanned aerial vehicle or an unmanned ground vehicle navigates an area, it is necessary to plan the navigation route in advance to more effectively achieve the automatic navigation in the area.

The existing technology requires the user to mark all waypoints in a designated navigation area in one shot. When new waypoints need to be added, the navigation route formed by the original waypoints has to be deleted, and a new navigation route may have to be entered including both original and new waypoints, thereby wasting time and effect.

### SUMMARY

In accordance with the disclosure, there is provided a navigation route editing method including, when a new corner point is added, determining one of initial corner points of an initial area as a connecting corner point based on locations of the initial corner points and a location of the new corner point. The new corner point and the connecting corner point form end points of a to-be-analyzed line section, and the initial area includes boundary line sections each having two adjacent ones of the initial corner points as end points. The method further includes determining whether one of the boundary line sections has an intersecting relationship with the to-be-analyzed line section, and, if not, determining a target area including the new corner point and the initial corner points. The method also includes planning a navigation route in the target area.

Also in accordance with the disclosure, there is provided a control device including a user interface configured to process interactive data and a processor coupled to the user interface. The processor is configured to, when a new corner point is added, determine one of initial corner points of an initial area as a connecting corner point based on locations of the initial corner points and a location of the new corner point. The new corner point and the connecting corner point form end points of a to-be-analyzed line section, and the initial area includes boundary line sections each having two adjacent ones of the initial corner points as end points. The processor is further configured to determine whether one of the boundary line sections has an intersecting relationship with the to-be-analyzed line section, and, if not, determine a target area including the new corner point and the initial corner points. The processor is also configured to plan a navigation route in the target area.

### BRIEF DESCRIPTION OF THE DRAWINGS

To more clearly illustrate the technical solution in the present disclosure, the accompanying drawings used in the description of the disclosed embodiments are briefly described hereinafter. Obviously, the drawings described below are merely some embodiments of the present disclosure. Other drawings may be derived from such drawings by a person with ordinary skill in the art without creative efforts and may be encompassed in the present disclosure.

FIG. 1 is a schematic diagram of a cruising area editing interface according to an example embodiment.

FIG. 2 is a schematic diagram of an interface of editing a navigation route in a cruising area according to an example embodiment.

FIG. 3 is a schematic diagram of a navigation route editing interface according to an example embodiment.

FIG. 4 is a schematic diagram of a user interface after adding a waypoint according to an example embodiment.

FIG. 5 is a schematic diagram of a user interface after adding another waypoint according to an example embodiment.

FIG. 6 is a flow chart of a navigation route editing method according to an example embodiment.

FIG. 7 is a flow chart of another navigation route editing method according to an example embodiment.

FIG. 8 is a schematic diagram of a navigation route editing apparatus according to an example embodiment.

FIG. 9 is a schematic diagram of a control device according to an example embodiment.

### DETAILED DESCRIPTION OF THE EMBODIMENTS

Technical solutions of the present disclosure will be described with reference to the drawings. It will be appreciated that the described embodiments are some rather than all of the embodiments of the present disclosure. Other embodiments conceived by those having ordinary skills in the art on the basis of the described embodiments without inventive efforts should fall within the scope of the present disclosure.

In some embodiments, a cruising target area may be dynamically set to allow a process of setting a cruising navigation route in the target area to be executed by a single control device, such as a personal computer, a tablet computer, or a high performance smart phone. In some embodiments, a process of dynamically setting a target area of cruising may be divided between a front-end client and a back-end server. The front-end client may include a smart phone or a tablet computer with a touch screen. The front-end client may display an editing interface and facilitate a user to perform marking operations (such as clicking on the touch screen) on the editing interface while the back-end server may perform a dynamic planning process of locations of corner points and newly added corner points designated by clicking operations of the front-end client in the target area to achieve a dynamic editing of a cruising flight route in the target area. In the present disclosure, for illustrative purposes, the flight route editing method is described as being implemented by a single control device.

In some embodiments, the method may involve corner points, corner points of obstacles, and waypoints. The corner points may be used to define a cruising area, and may refer to inflection points on the boundary of the cruising area. The waypoints may include location points that a movable object such as an aerial vehicle passes through in the cruising area defined by the corner points.

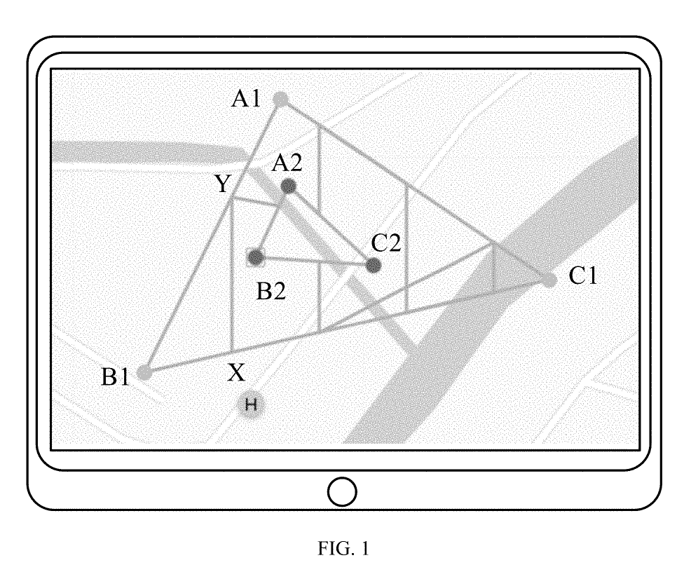

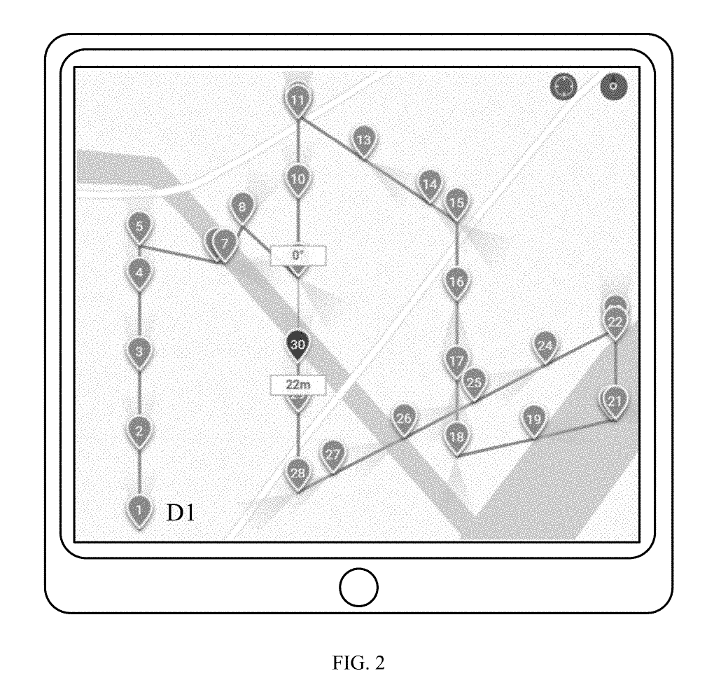

FIG. 1 is a schematic diagram of a cruising area editing interface according to an example embodiment. FIG. 2 is a schematic diagram of an interface of editing a navigation route in a cruising area according to an example embodiment. As shown in FIG. 1, a user marks corner points A1, B1, and C1 by clicking on the touch screen. A triangle area A1B1C1 may be enclosed based on the locations of the three corner points. The triangle area may be a cruising area. In some embodiments, the user may control a movable object such as an aerial vehicle to traverse the boundary of a cruising area. Based on the location coordinates uploaded by the movable object, locations of a plurality of inflection points may be determined as the corner points. Line sections between the corner point A1 and the corner point B1, between the corner point B1 and the corner point C1, and between the corner point C1 and the corner point A1 may be called boundary line sections.

Further, as shown in FIG. 1, the cruising area includes the obstacle corner points A2, B2, and C2. The obstacle corner points may be corner points determined by clicking on the touch screen according to actual environment shown on a map. In some embodiments, when sensors such as a visual sensor and a distance sensor detect an obstacle, a movable object such an aerial vehicle may automatically set a plurality of obstacle corner points. In some embodiments, a triangle area A2B2C2 enclosed by the obstacle corner points A2, B2, and C2 may be an area where the movable object is prohibited from entering. That is, no waypoints of navigation route may be set in the prohibited area. As shown in FIG. 2, the navigation route is set in the triangle area A1B1C1. The navigation route may include a plurality of waypoints such as the waypoint D1. Each digit location may be a waypoint. All of the waypoints together may form the navigation route in the triangle area A1B1C1. It can be seen that the navigation route between the waypoint D1 corresponding to the location point 1 and the waypoint corresponding to the location point 5 is actually the line section XY in FIG. 1. Correspondingly, the navigation routes between other location points may correspond to other line sections in FIG. 1.

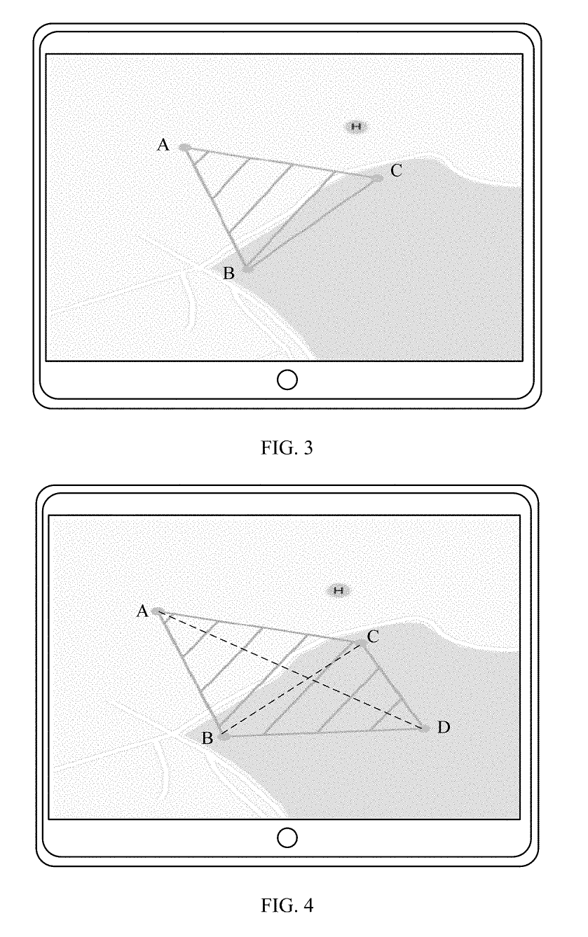

FIG. 3 is a schematic diagram of a navigation route editing interface according to an example embodiment. When a user edits a navigation route on an APP, the control device displays the interface shown in FIG. 3. As shown in FIG. 3, the user marks three points in a regional map in the interface by touching on the touch screen or clicking a mouse to obtain the corner point A, the corner point B, and the corner point C. Upon completion of the marking, the control device obtains a polygon-shaped (a triangle) area shown in FIG. 3 based on the corner point A, the corner point B, and the corner point C. The polygon-shaped area is the user intended area where the aerial vehicle cruises for purposes such as monitoring the area or spraying pesticides. As shown in FIG. 3, the circled H is the designated return point or landing point upon completion of the cruising.

Further, the user may configure camera related parameters such as a photographing height, a photographing angle, and a camera field of view (FOV), and cruising related parameters such as any one or more of a starting point (i.e., a starting corner point), a cruising direction, a number of coordinated aerial vehicles, a cruising overlap rate, a return location point, a flight base location point, or an obstacle location point. At the flight base, the aerial vehicle may be operated on for battery replacement and repairing. Based on the parameters and the location coordinates of the corner points, the control device may automatically calculate a more detailed cruising route for the aerial vehicle to achieve the function of covering an concerned area by cruising an unmanned aerial vehicle.

After editing the cruising area, the user may continue to add new corner points (first corner points) by touching on the touch screen or equivalent. The control device may treat the already edited cruising area as the initial area. Upon detecting a first corner point being added in an adding-new-corner-point operation, the control device may determine the location coordinate of the first corner point on the map, and based on the location coordinates of all of the corner points in the initial area, determine a location for the newly added first corner point to be inserted. The corner points already in the initial area are also referred to as “initial corner points.” The rule of inserting a first corner point may include forming a line section between the first corner point and a certain corner point in the initial area without intersecting any boundary line section in the area. In some embodiments, the intersection of line sections does not include intersecting at an end point of a line section.

FIG. 4 is a schematic diagram of a user interface after adding a waypoint according to an example embodiment. As shown in FIG. 4, after the line sections (i.e., boundary line sections) between the corner points A, B, and C form the cruising area (i.e., the initial area), a first corner point D is added at a certain location shown in FIG. 4. The line section DC connecting between the first corner point D and the initial corner point C does not intersect with any other line section in the initial area except for intersecting with the boundary line section AC at the end point C. Thus, the first corner point D may be inserted between the corner point B and the corner point C. The corner point B is a third corner point. A distance between the corner point B and the corner point D is greater than a distance between the corner point C and the corner point D, and smaller than a distance between the corner point A and the corner point B. On the other hand, the line section DA connecting between the first corner point D and the initial corner point A intersects with the boundary line section BC. Thus, the first corner point D may not be adjacent to and form a boundary line section of the target area with the corner point A.

In other words, the only rule for determining the insertion location in the plurality of corner points for a dynamically inserted corner point of the polygon may include ensuring no line section intersects, that is, maintaining the polygon shape. The corresponding algorithm is described below.

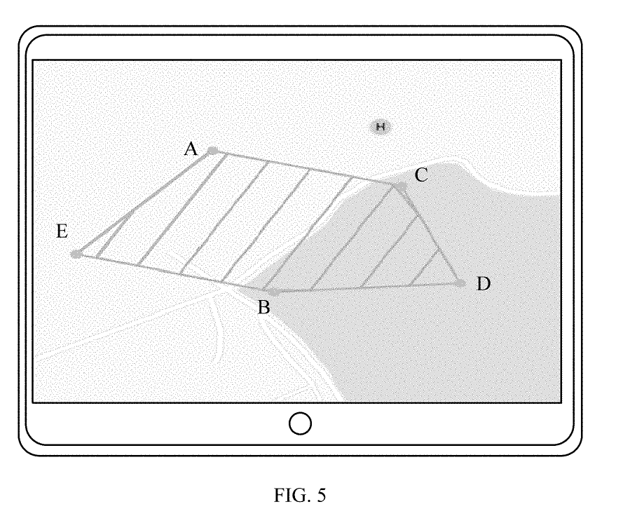

First, the distances between the inserted corner point (the first corner point) and other corner points (the corner points in the initial area) may be calculated and sorted in an ascending order. FIG. 5 is a schematic diagram of a user interface after another waypoint is added according to an example embodiment. As shown in FIG. 5, a new first corner point E is further added to the cruising area shown in FIG. 4. Based on the distances to the first corner point E, the sorting result is the corner points A, B, C, and D.

Further, because the first corner point is located between two corner points of a certain boundary line section, each and every boundary line section may be traversed to determine the intersection scenario (excluding intersecting at an end point) assuming that the first corner point is inserted in the boundary line section. As shown in FIG. 5, the boundary line sections include a boundary line section AB between the corner point A and the corner point B, a boundary line section BD between the corner point B and the corner point D, a boundary line section DC between the corner point D and the corner point C, and a boundary line section CA between the corner point C and the corner point A. Based on the ascending order of the distances, the first corner point E is first connected to the nearest corner point A to form the line section EA, and whether an intersecting condition between the line section EA and every other boundary line section is satisfied is determined. When none of the line sections AB, BD, DC, and CA satisfies the intersecting condition (excluding intersecting at the corner point A), the first corner point E may be inserted between the corner point A and the corner point B. The distance between the corner point B and the first corner point E may be greater than only the distance between the corner point A and the first corner point E. An updated target area may be obtained by replacing the initial boundary line section AB with the boundary line sections AE and EB.

The rule of determining whether two line sections intersect is described below. For example, the two line sections are a line section AB and a line section CD (not related to FIGS. 3-5). First, whether the line where the line section AB is located intersects with the line section CD is determined. If the line where the line section AB is located does not intersect with the line section CD, then the line section AB does not intersects with the line section CD. If the line where the line section AB is located intersects with the line section CD, then whether the line where the line section CD is located intersects with the line section AB is determined. If the line where the line section CD is located does not intersect with the line section AB, then the line section AB does not intersect with the line section CD. If the line where the line section AB is located intersects with the line section CD and the line where the line section CD is located intersects with the line section AB, then the line section AB intersects with the line section CD. In other words, for two line sections, if a line where any one of the two line sections is located does not intersect with the other of the two line sections, then the two line sections do not intersect with each other. On the other hand, if a line where one of the two line sections is located intersects with the other of the two line sections and a line where the other of the two line sections is located intersects with the one of the two line sections, the two line sections intersect with each other.

A method for determining whether the line where the line section AB is located intersects with the line section CD. Assume the line where the section AB is located is defined by an equation f(x,y)=0. When the point C and the point D are not located on a same side of the line, the line where the line section AB is located intersects with the line section CD. That is, the condition that the line where the line section AB is located intersects with the line section CD is f(C)*f(D)≤0.

Assume that the coordinates of the points A, B, C, and D are (Xa, Ya), (Xb, Yb), (Xc, Yc), and (Xd, Yd), respectively. The line where the line section AB is located is represented by

$$\frac{y - {y}_{a}}{x - {x}_{a}} = \frac{{y}_{b} - {y}_{a}}{{x}_{b} - {x}_{a}} .$$

Further, the following equations are obtained:

f(C)=(y_{c}−yₐ)(x_{b}−x_{c})−(x_{c}−xₐ)(y_{b}−yₐ);

f(D)=(y_{d}−y_{d})(x_{b}−xₐ)−(x_{d}−xₐ)(y_{b}−yₐ).

If f(C)*f(D)≤0 (the point C and the point D are located on different sides of the line where the line section AB is located), then the line where the line section AB is located intersects with the line section CD. Similarly, whether the line where the line section CD is located intersects with the line section AB is determined. If the line where the line section AB is located intersects with the line section CD and the line where the line section CD is located intersects with the line section AB, then it can be determined that the line section AB intersects with the line section CD.

In some embodiments, the line sections to be analyzed are sorted in an ascending order of the distances between the corner point and the line sections. Each and every line section in the initial area is sequentially traversed. The rule described above is used to determine whether a line section to be analyzed intersects with any boundary line section. If the line section to be analyzed does not intersect with any boundary line section, then the insertion position of the new corner point is determined. If the line section to be analyzed intersects with any boundary line section, then next corner point is sequentially obtained. Then the same operations are repeated until a line section to be analyzed that does not have a relationship with any boundary line section satisfying the intersecting condition (excluding intersecting at an end point) is found and the insertion position of the first corner point is determined.

Further, obstacles may exist in a polygon-shaped cruising area. The user may manually mark a plurality of obstacle corner points to circumvent an obstacle on a map or the control device may determine a plurality of obstacle corner points to circumvent an obstacle through an automatic recognition method. Based on the locations of the obstacle corner points, the process of determining the insertion position of the first corner point is sequentially executed to the corner points according to a certain order to update the initial area. The certain order may be the marking time sequence.

A corner point D (a first corner point) is inserted to the lower right corner of FIG. 3 to obtain FIG. 4. A corner point E (a first corner point) is inserted to the lower left corner of FIG. 4 to obtain FIG. 5. It can be seen that the control device returns the reliable calculation results in both cases. That is, the polygon-shaped cruising areas without intersecting are obtained.

In some embodiments, the front-end client and the back-end server may together perform the process of obtaining the desired cruising target area. The operation process and rule may be substantially the same as the operation process and rule of the control device. The difference may include information exchange between the front-end client and the back-end server. For example, the location of the first corner point received by the front-end client from a user interface may have to be transmitted to the back-end server through wire-line or wireless communication.

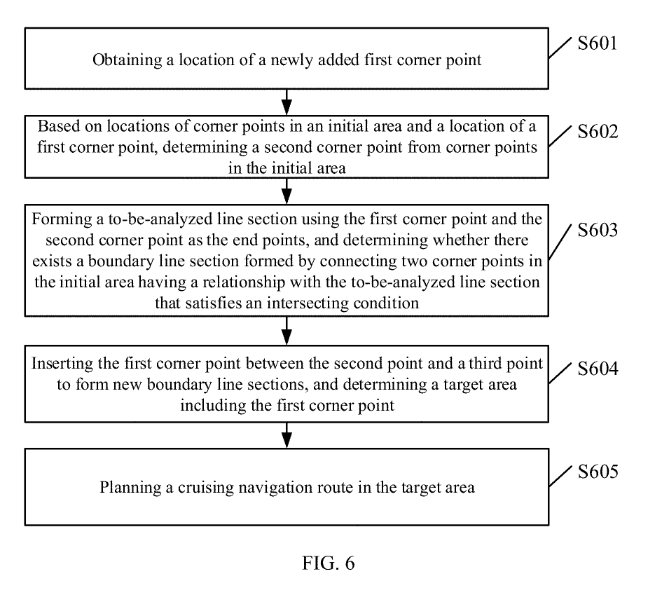

FIG. 6 is a flow chart of a navigation route editing method according to an example embodiment. The method may be executed by the control device or the server. As shown in FIG. 6, the method includes the following processes.

S601: obtaining a location of a newly added first corner point. The first corner point may be a corner point newly marked by a user on a map interface. Based on the location of the newly added corner point on the map, the location of the first corner point may be obtained, and the location may be a GPS (global positioning system) coordinate.

S602: based on locations of corner points in an initial area and a location of a first corner point, determining a second corner point from corner points in the initial area. The initial area may be a desired cruising area that has been edited. That is, the initial area needs to be edited. The initial area may be a polygon-shaped cruising area. The second corner point may be one of the corner points in the initial area, and may also be referred to as a “connecting corner point.” Based on the distances between the first corner point and the corner points in the initial area, the corner points in the initial area may be sorted in an ascending order. The sorted series of the corner points may be sequentially analyzed to obtain the second corner point.

S603: forming a to-be-analyzed line section using the first corner point and the second corner point as the end points, and determining whether there exists a boundary line section formed by connecting two corner points in the initial area having a relationship with the to-be-analyzed line section that satisfies an intersecting condition. In this disclosure, two line sections having a relationship satisfying an intersecting condition is also referred to as two line sections having an intersecting relationship.

In some embodiments, the to-be-analyzed line section may be compared to any boundary line section formed by connecting any two corner points in the initial area to determine whether the to-be-analyzed line section has a relationship with any of the boundary line sections that satisfies the intersecting condition. If there exists a line section in the boundary line sections having a relationship with the to-be-analyzed line section that satisfies the intersecting condition, then the analysis process ends, and a new second corner point may be determined to form a new to-be-analyzed line section. That is, S602 is repeated. If there does not exist a line section in the boundary line sections having a relationship with the to-be-analyzed line section that satisfies the intersecting condition, then S604 may be executed.

S604: inserting the first corner point between the second point and a third point to form new boundary line sections, and determining a target area including the first corner point. The target area may be enclosed by a portion of the boundary line sections in the initial area and the new boundary line sections including the newly inserted first corner point.

The third corner point may be in the initial area, and may also be referred to as a connecting corner point. That is, the second corner point may be a first connecting corner point and the third corner point may be a second connecting corner point. The distance between the third point and the first corner point may be greater than only the distance between the second corner point and the first corner point. That is, the distance between the third corner point and the first corner point is greater than the distance between the second corner point and the first corner point, and is smaller than a distance between any of the corner points in the initial area excluding the second corner point and the first corner point.

The newly formed boundary line sections may replace the original boundary line section between the second corner point and the third corner point. For example, as shown in FIG. 4, the newly formed boundary line sections BD and DC replace the original boundary line section BC. In another example, as shown in FIG. 5, the newly formed boundary line sections AE and EB replace the original boundary line section AB.

S605: planning a cruising navigation route in the target area.

In some embodiments, the user only needs to designate a new corner point, determines an insertion position of the new corner point by analyzing whether two line sections intersect, and redraws a desired cruising area. The navigation route may be processed in the redrawn area to satisfy the user's need of editing the navigation route in the cruising area. Thus, the cruising area may be dynamically adjusted, and the efficiency of editing the navigation route in the cruising area may be improved.

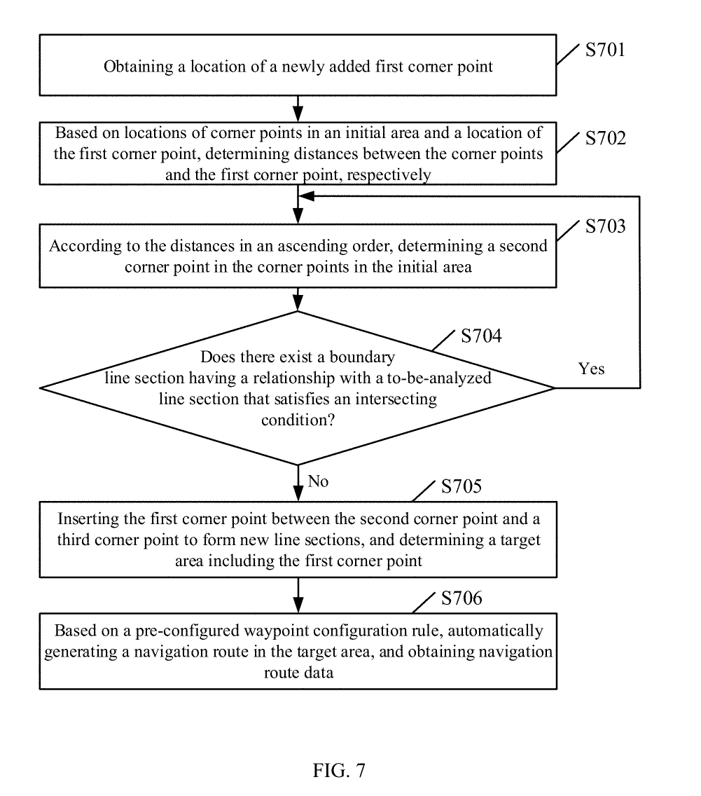

FIG. 7 is a flow chart of another navigation route editing method according to an example embodiment. The method may be executed by the control device or the server. As shown in FIG. 7, the method includes the following processes.

S701: obtaining a location of a newly added first corner point. The initial area may be a desired cruising area that has been edited. The initial area may be a polygon-shaped area obtained based on the corner points configured on an interactive interface. The location of the first corner point may be a corner point newly marked by the user.

S702: based on locations of corner points in an initial area and a location of the first corner point, determining distances between the corner points and the first corner point, respectively. A distance between two points may be calculated based on the GPS coordinates of the two points.

S703: according to the distances sorted in an ascending order, determining a second corner point in the corner points in the initial area. In some embodiments, a corner point series may be generated by sorting the corner points according to the ascending order of the distances, such that the corner points may be sequentially obtained from the series of the corner points as the second corner point. In some embodiments, the corner point having the shortest distance to the first corner point can be determined as the second corner point. This is also referred to as determining the second corner point according to a priority order of ascending distances.

S704: forming a to-be-analyzed line section using the first corner point and the second corner point as the end points, and determining whether there exists a boundary line section formed by connecting two corner points in the initial area having a relationship with the to-be-analyzed line section that satisfies an intersecting condition.

A line section formed by two corner points in the initial area is a boundary line section. The intersecting condition requires that two line sections intersect with each other, but excludes intersecting at an end point. The rule of determining whether a relationship between the to-be-analyzed line section and a boundary line section satisfies the intersecting condition includes the following logics. If a line where the to-be-analyzed line section is located does not intersect with a boundary line section, then a relationship between the to-be-analyzed line section and the boundary line section does not satisfy an intersecting condition. Otherwise, if a line where the boundary line section is located does not intersect with the to-be-analyzed line section, then the relationship between the to-be-analyzed line section and the boundary line section does not satisfy the intersecting condition. Otherwise, if the line where the to-be-analyzed line section is located intersects with the boundary line section and the line where the boundary line section is located intersects with the to-be-analyzed line section, then the relationship between the to-be-analyzed line section and the boundary line section satisfies the intersecting condition. Otherwise, if the line where the to-be-analyzed line section is located intersects with the boundary line section, but the line where the boundary line section is located does not intersect with the to-be-analyzed line section, then the relationship between the to-be-analyzed line section and the boundary line section does not satisfy the intersecting condition. Otherwise, if the line where the boundary line section is located intersects with the to-be-analyzed line section, but the line where the to-be-analyzed line section is located does not intersect with the boundary line section, then the relationship between the to-be-analyzed line section and the boundary line section does not satisfy the intersecting condition. For the calculation algorithm, reference can be made to the descriptions of the embodiments above.

When the determination result is negative, i.e., there does not exist a line section that the relationship between the line section and the to-be-analyzed line section satisfies the intersecting condition, S705 is executed. Otherwise, there exists a line section that the relationship between the line section and the to-be-analyzed line section satisfies the intersecting condition. Hence, a new corner point may be determined from the remaining corner points in the initial area according to the ascending order of distances to be the second corner point, i.e., the process returns to S703.

S705: inserting the first corner point between the second corner point and a third corner point to form new line sections, and determining a target area including the first corner point. The third corner point may be in the initial area. A distance between the third corner point and the first corner point may be greater than only a distance between the second corner point and the first corner point. The third corner point may be the corner point subsequent to the second corner point in the series of corner points described in S703. The newly formed boundary line sections may replace the original boundary line section between the second corner point and the third corner point.

S706: based on a pre-configured waypoint configuration rule, automatically generating a navigation route in the target area, and obtaining navigation route data. The route data may include a plurality of waypoints and locations of the waypoints, such that a movable object may perform cruising the target area when moving according to the route data.

In some embodiments, when a navigation route is automatically generated, the data corresponding to the navigation route may be transmitted directly to an aerial vehicle executing a cruising task or other desired movable object, such that the aerial vehicle or other desired movable object may cruise the target area. If the navigation route is substantially long, the automatically generated navigation route may be divided. A plurality of divided sub-routes may be transmitted to one or a plurality of movable objects, respectively, to control the movable objects to cruise the corresponding sub-routes, such that the target area may be cruised in sections. Moreover, before or after or at the same time as the route data is transmitted, special location point information may be transmitted to the desired movable object cruising the corresponding route. The special location points may include one or more of a return-to-base location point, a flight base location point, or an obstacle location point.

In some embodiments, the method shown in FIG. 7 may be implemented by a server. The process that the server generates a desired cruising area in response to the user's marking of a corner point may include the following processes. The server may receive corner point data including a plurality of corner points transmitted by the client terminal. The plurality of corner points may be inputted through an interactive interface of the client terminal by a user. The corner point data may include locations of the corner points. A desired cruising area may be generated based on the corner point data of all of the corner points, and a navigation route may be configured in the desired cruising area. The configured navigation route may be transmitted to the client terminal and may be displayed to the user. A navigation route may be generated in the desired cruising area defined by the corner points marked by the user through interacting with the control device or other client terminal.

Further, the process that the server inserts a new corner point may include the following processes. The data of the corner point to be inserted received by the client terminal may be obtained. The data of the corner point to be inserted may include data of a corner point newly inserted in the initial area received in the user interface of the client terminal. Obtaining a location of a newly added first corner point may be executed. Similarly, through interacting with the control device or other client terminal, the server may generate a navigation route including the newly inserted corner point for the user.

In some embodiments, if the user generated initial area or a plurality of corner points inserted in the initial area results in a substantially large target area, then the navigation route generated in the target area may be substantially long (longer than a length threshold), or the number of waypoints are substantially large (larger than a number threshold), or the reaming electric power in the aerial vehicle is insufficient to complete the navigation route. As a result, the navigation route may be divided. A plurality of divided sub-routes may be transmitted to one or more target aerial vehicle to control the aerial vehicles to cruise the corresponding sub-routes. In some embodiments, the divided sub-routes may be transmitted sequentially to one aerial vehicle based on the location where the sub-route is located on the original complete route.

In some embodiments, an obstacle area such as a building or a hill may exist in the planned target area. Before planning the cruising navigation route, the method of the present disclosure may further include the following processes. An existence of an obstacle location area may be detected in the target area. Based on the obstacle location area, a plurality of obstacle corner points may be determined. Based on the obstacle location area determined by the obstacle corner points in the target area, a desired cruising navigation route may be planned avoiding the obstacle area. The location and approximate area of the obstacle may be obtained by processing the data collected by cameras, supersonic sensors, infrared sensors, and distance sensors individually or comprehensively.

In some embodiments, the user may configure the obstacle area in the user interface displaying the target area based on the actual geographic environment. Before planning the cruising navigation route, the method of the present disclosure may include determining an obstacle location area configured in the target area based on received user operation events, such that the desired cruising navigation area may be planned avoiding the obstacle area in the target area. The user operation events may refer to the operations on a graph of a pre-configured area. The operations on the graph of the pre-configured area may include at least one of a selection operation to select one or more area graphs from a pre-configured set of various area graphs, a placement operation to place one or more selected area graphs in the target area, a location adjustment operation to adjust the locations of one or more area graphs already placed in the target area, or a dimension adjustment operation to adjust the dimension of any of the one or more area graphs already placed in the target area.

The pre-configured area graphs may include a circle graph, a square graph, a rectangular graph, and a hexagon graph, etc. Through a long pressed operation, the user may select an area graph from the interface displaying the graph set. The location of the area graph may be adjusted by dragging the area graph already placed in the target area. The dimension (e.g., a length of a side, a radius of a circle, etc.) of the area graph may be adjusted by dragging a side or a corner of the area graph already placed in the target area.

In some embodiments, the user may simply designate a new corner point and determine an insertion location by deciding whether two line sections intersect with each other to redraw a desired cruising area. Thus, the navigation route may be edited in the redrawn cruising area to satisfy the user's need for editing the cruising navigation route, the cruising area may be dynamically configured, and the efficiency of editing the cruising navigation route may be achieved.

FIG. 8 is a schematic diagram of a navigation route editing apparatus according to an example embodiment. The apparatus may include the control device or the server. In some embodiments, the apparatus may include an acquisition circuit 801 configured to acquire a location of a newly added first corner point, a determination circuit 802 configured to determine a second corner point from the corner points in an initial area based on the location of the corner points and the location of the first corner point, a decision circuit 803 configured to form a to-be-analyzed line section using the first corner point and the second corner point and to decide whether there exists a line section formed by connecting two corner points in the initial area and having a relationship with the to-be-analyzed line section satisfying an intersecting condition, and an editing circuit 804 configured to, when the decision of the decision circuit 803 is non-existent, insert the first corner point between the second corner point and a third corner point, determine a target area including the first corner point, and plan a cruising navigation route in the target area. The third corner point is located in the initial area. A distance between the third corner point and the first corner point may be greater than only a distance between the second corner point and the first corner point.

In some embodiments, based on the locations of the corner points in the initial area and the location of the first corner point, the determination circuit 802 may determine distances between the various corner points in the initial area and the first corner point, and may determine the second corner point from the corner points in the initial area according to a priority order of ascending distances.

In some embodiments, the determination circuit 802 may be configured to further determine a new corner point as the second corner point from the remaining corner points in the initial area according to the priority order to ascending distances when the decision of the decision circuit 803 is that there exists a line section having a relationship with the to-be-analyzed line section satisfying the intersecting condition. The decision circuit 803 may be triggered to make a corresponding decision based on the determined second corner point.

In some embodiments, the apparatus may further include a detection circuit 805 to detect an existence of an obstacle location area in the target area. A plurality of obstacle corner points may be determined based on the obstacle location area. An obstacle area in the target area may be obtained based on the obstacle corner points, such that a desired cruising navigation route may be planned to avoid the obstacle area. The initial area may be a polygon-shaped area obtained by planning based on the corner points configured in an interactive interface.

In some embodiments, the apparatus may further include a configuration circuit 809 to determine an obstacle location area configured in the target area according to the received user operation events, such that the desired cruising navigation route may be planned avoiding the obstacle area.

The user operation events may refer to the operations on a graph of a pre-configured area. The operations on the graph of the pre-configured area may include at least one of a selection operation to select one or more area graphs from a pre-configured set of various area graphs, a placement operation to place one or more selected area graphs in the target area, a location adjustment operation to adjust the locations of one or more area graphs already placed in the target area, or a dimension adjustment operation to adjust the dimension of any of the one or more area graphs already placed in the target area.

In some embodiments, the decision circuit 803 may be configured further to determine whether a relationship between the to-be-analyzed line section and a boundary line section satisfies the intersecting condition. If a line where the to-be-analyzed line section is located does not intersect with a boundary line section, then a relationship between the to-be-analyzed line section and the boundary line section does not satisfy an intersecting condition. Otherwise, if a line where the boundary line section is located does not intersect with the to-be-analyzed line section, then the relationship between the to-be-analyzed line section and the boundary line section does not satisfy the intersecting condition. Otherwise, if the line where the to-be-analyzed line section is located intersects with the boundary line section and the line where the boundary line section is located intersects with the to-be-analyzed line section, then the relationship between the to-be-analyzed line section and the boundary line section satisfies the intersecting condition. Otherwise, if the line where the to-be-analyzed line section is located intersects with the boundary line section, but the line where the boundary line section is located does not intersect with the to-be-analyzed line section, then the relationship between the to-be-analyzed line section and the boundary line section does not satisfy the intersecting condition. Otherwise, if the line where the boundary line section is located intersects with the to-be-analyzed line section, but the line where the to-be-analyzed line section is located does not intersect with the boundary line section, then the relationship between the to-be-analyzed line section and the boundary line section does not satisfy the intersecting condition.

In some embodiments, the apparatus may further include a processing circuit 806 to automatically generate a navigation route in the target area according to a pre-configured waypoint configuration rule, and to obtain navigation route data. The navigation route data may include a plurality of waypoints and locations of the waypoints, such that a movable object may cruise the target area by moving according to the route data.

In some embodiments, the processing circuit 806 may be configured to obtain insertion corner point data received by the client terminal. The insertion corner point data may include data of a newly inserted corner point received by the user interface of the client terminal. The acquisition circuit 801 may be triggered to obtain the location of the newly added first corner point.

In some embodiments, the apparatus may further include a division circuit 807 to divide the automatically generated navigation route, and a transmitting circuit 810 to transmit a plurality of divided navigation sub-routes to one or more movable objects, respectively, to control various movable objects to cruise the corresponding navigation sub-routes.

In some embodiments, the apparatus may further include a control circuit 808 to transmit special location point information to the desired movable object cruising the corresponding route. The special location points may include one or more of a return-to-base location point, a flight base location point, or an obstacle location point.

For the implementation of individual circuits of the apparatus, the description of the related parts in various embodiments of the present disclosure may be referenced, and details are not repeated herein.

In some embodiments, the user only needs to designate a new corner point, determines an insertion position of the new corner point by analyzing whether two line sections intersect, and redraws a desired cruising area. The navigation route may be processed in the redrawn area to satisfy the user's need of editing the navigation route in the cruising area. Thus, the cruising area may be dynamically adjusted, and the efficiency of editing the navigation route in the cruising area may be improved.

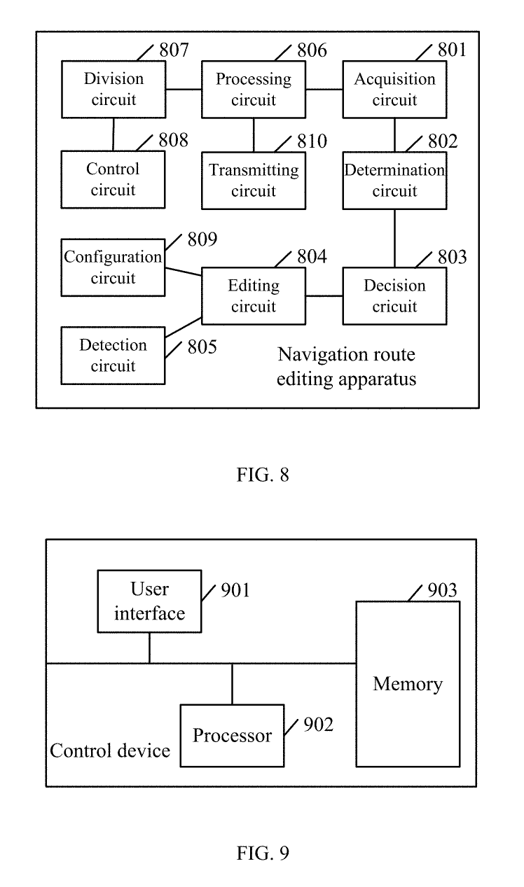

FIG. 9 is a schematic diagram of a control device according to an example embodiment. The control device of the present disclosure may include a personal computer, a smart phone, a tablet computer, or a server. As shown in FIG. 9, the control device may further include a user interface 901, a processor 902, and a memory 903. The control device may also include a power supply circuit, a communication circuit, a physical keyboard, and an enclosure.

The user interface 901 may process the user interaction data, and may include a touch screen.

The memory 903 may include a volatile memory or a non-volatile memory. The memory 903 may also include a combination of the volatile memory and the non-volatile memory. The processor 902 may include a central processing unit (CPU). The processor 902 may further include hardware chips. The hardware chips may include an application-specific integrated circuit (ASIC), a programmable logic device (PLD), or a combination thereof. The PLD may include a complex programmable logic device (CPLD), a field-programmable gate array (FPGA), or a combination thereof.

In some embodiments, the memory 903 may store program instructions. The processor 92 may retrieve the program instructions to implement the navigation route editing method shown in FIG. 6 and FIG. 5.

In some embodiments, the processor 902 may retrieve the program instructions to execute the following processes.

When a first corner point is newly added, a second corner point may be determined from the corner points in the initial area according to the locations of the corner points in the initial area and the location of the first corner point.

A to-be-analyzed line section may be formed using the first corner point and the second corner point as the end points. From the boundary line sections formed by connecting two corner points in the initial area, whether there exists a line section having a relationship with the to-be-analyzed line section satisfying an intersecting condition may be decided.

If there does not exist a line section having a relationship with the to-be-analyzed line section satisfying the intersecting condition, the first corner point may be inserted between the second corner point and a third corner point to determine a target area including the first corner point. The third corner point is located in the initial area. A distance between the third corner point and the thirst corner point may be greater than only a distance between the second corner point and the first corner point.

A desired cruising navigation route may be planned in the target area.

In some embodiments, the processor 902 may retrieve the program instructions to execute the following processes when determining the second corner point from the corner points in the initial area according to the locations of the corner points in the initial area and the location of the first corner point.

The distances between various corner points in the initial area and the first corner point may be determined according to the locations of the corner points in the initial area and the location of the first corner point.

According to the distances sorted in an ascending order, the second corner point may be determined from the corner points in the initial area.

In some embodiments, the processor 902 may retrieve the program instructions to further execute the following processes.

If there exists a line section having a relationship with the to-be-analyzed line section satisfying the intersecting condition, a new second corner point may be further determined from the remaining corner points in the initial area according to the priority order of the ascending distances.

The further determined second corner point may trigger the execution of forming the to-be-analyzed line section using the first corner point and the second corner point as the end points and determining whether there exists a line section having a relationship with the to-be-analyzed line section satisfying the intersecting condition from the boundary line sections formed by connecting two corner points in the initial area.

In some embodiments, the processor 902 may retrieve the program instructions to further execute the following processes.

An existence of an obstacle location area may be detected in the target area. A plurality of obstacle corner points may be determined according to the obstacle location area. An obstacle area may be obtained in the target area based on the obstacle corner points, such that a desired cruising navigation route may be planned avoiding the obstacle area in the target area.

The initial area may include a polygon-shaped area obtained by planning according to the corner points configured in the interactive interface.

In some embodiments, the processor 902 may retrieve the program instructions to further execute the following processes.

Based on received user operation events, an obstacle location area configured in the target area may be determined, such that the desired cruising navigation area may be planned avoiding the obstacle area in the target area. The user operation events may refer to the operations on a graph of a pre-configured area. The operations on the graph of the pre-configured area may include at least one of a selection operation to select one or more area graphs from a pre-configured set of various area graphs, a placement operation to place one or more selected area graphs in the target area, a location adjustment operation to adjust the locations of one or more area graphs already placed in the target area, or a dimension adjustment operation to adjust the dimension of any of the one or more area graphs already placed in the target area.

In some embodiments, a boundary line section may be formed by connecting two corner points in the initial area. The intersecting condition may include that two line sections intersect with each other excluding intersecting at any end point. The processor 902 may retrieve the program instructions to further execute the following processes to decide whether a relationship between the to-be-analyzed line section and a boundary line section satisfies the intersecting condition.

If a line where the to-be-analyzed line section is located does not intersect with a boundary line section, then a relationship between the to-be-analyzed line section and the boundary line section does not satisfy an intersecting condition. Otherwise, if a line where the boundary line section is located does not intersect with the to-be-analyzed line section, then the relationship between the to-be-analyzed line section and the boundary line section does not satisfy the intersecting condition. Otherwise, if the line where the to-be-analyzed line section is located intersects with the boundary line section and the line where the boundary line section is located intersects with the to-be-analyzed line section, then the relationship between the to-be-analyzed line section and the boundary line section satisfies the intersecting condition. Otherwise, if the line where the to-be-analyzed line section is located intersects with the boundary line section, but the line where the boundary line section is located does not intersect with the to-be-analyzed line section, then the relationship between the to-be-analyzed line section and the boundary line section does not satisfy the intersecting condition. Otherwise, if the line where the boundary line section is located intersects with the to-be-analyzed line section, but the line where the to-be-analyzed line section is located does not intersect with the boundary line section, then the relationship between the to-be-analyzed line section and the boundary line section does not satisfy the intersecting condition.

In some embodiments, the processor 902 may retrieve the program instructions to further execute the following instructions.

A navigation route in the target area may be automatically generated according to a pre-configured waypoint configuration rule, and route data may be obtained. The route data may include a plurality of waypoints and locations of the waypoints, such that a movable object may perform cruising the target area when moving according to the route data.

In some embodiments, the processor 902 may retrieve the program instructions to further execute the following processes.

Data of an insertion corner point received by the client terminal may be obtained. The data of the insertion corner point may include data of a newly inserted corner point received by the user interface of the client terminal.

Obtaining the location of the newly added first corner point may be triggered to be executed.

In some embodiments, the processor 902 may retrieve the program instructions to further execute the following processes.

The automatically generated navigation route may be divided. A plurality of divided navigation sub-routes may be transmitted to one or more movable objects respectively to control various movable objects to cruise the corresponding navigation sub-routes.

In some embodiments, the processor 902 may retrieve the program instructions to further execute the following processes.

Special location point information may be transmitted to the desired movable object cruising the corresponding route. The special location points may include one or more of a return-to-base location point, a flight base location point, or an obstacle location point.

For the implementation of the processor 902, the description of the related parts in various embodiments of the present disclosure may be referenced, and details are not repeated herein.

In some embodiments, the user only needs to designate a new corner point, determines an insertion position of the new corner point by analyzing whether two line sections intersect, and redraws a desired cruising area. The navigation route may be processed in the redrawn area to satisfy the user's need of editing the navigation route in the cruising area. Thus, the cruising area may be dynamically adjusted, and the efficiency of editing the navigation route in the cruising area may be improved.

Those of ordinary skill in the art will appreciate that the example elements and algorithm processes described above can be implemented in electronic hardware, or in a combination of computer software and electronic hardware. Whether these functions are implemented in hardware or software depends on the specific application and design constraints of the technical solution. One of ordinary skill in the art can use different methods to implement the described functions for different application scenarios, but such implementations should not be considered as beyond the scope of the present disclosure. For simplification purposes, detailed descriptions of the operations of example systems, devices, and units may be omitted and references can be made to the descriptions of the example methods.

The units described as separate components may or may not be physically separate, and a component shown as a unit may or may not be a physical unit. That is, the units may be located in one place or may be distributed over a plurality of network elements. Some or all of the components may be selected according to the actual needs to achieve the object of the present disclosure. In addition, the functional units in the various embodiments of the present disclosure may be integrated in one processing unit, or each unit may be an individual physically unit, or two or more units may be integrated in one unit.

A method consistent with the disclosure can be implemented in the form of computer program stored in a non-transitory computer-readable storage medium, which can be sold or used as a standalone product. The computer program can include instructions that enable a computer device, such as a processor, a personal computer, a server, or a network device, to perform part or all of a method consistent with the disclosure, such as one of the example methods described above. The storage medium can be any medium that can store program codes, for example, a USB disk, a mobile hard disk, a read-only memory (ROM), a random access memory (RAM), a magnetic disk, or an optical disk.

Other embodiments of the disclosure will be apparent to those skilled in the art from consideration of the specification and practice of the embodiments disclosed herein. It is intended that the specification and examples be considered as example only and not to limit the scope of the disclosure, with a true scope and spirit of the invention being indicated by the following claims.

What is claimed is:

1. A navigation route editing method comprising:
determining, in response to a new corner point being added, one of initial corner points of an initial area as a connecting corner point based on locations of the initial corner points and a location of the new corner point, the new corner point and the connecting corner point forming end points of a to-be-analyzed line section, and the initial area including boundary line sections each having two adjacent ones of the initial corner points as end points;
determining whether one of the boundary line sections has an intersecting relationship with the to-be-analyzed line section;
in response to determining that none of the boundary line sections has the intersecting relationship with the to-be-analyzed line section, determining a target area including the new corner point and the initial corner points; and
planning a navigation route in the target area.

2. The method of claim 1, wherein determining the one of the initial corner points as the connecting corner point includes:
based on the locations of the initial corner points and the location of the new corner point, determining distances between the initial corner points and the new corner point; and
determining the connecting corner point from the initial corner points according to an ascending order of the distances.

3. The method of claim 2, further comprising:
in response to determining that one of the boundary line sections has the intersecting relationship with the to-be-analyzed line section, determining a new connecting corner point from remaining ones of the initial corner points except the connecting corner point according to the ascending order of the distances, the new corner point and the new connecting corner point forming end points of a new to-be-analyzed line section; and
determining whether one of the boundary line sections has an intersecting relationship with the new to-be-analyzed line section.

4. The method of claim 1, further comprising:
detecting existence of an obstacle location area in the target area;
based on the obstacle location area, determining a plurality of obstacle corner points; and
based on the plurality of obstacle corner points, obtaining an obstacle area in the target area;
wherein the navigation route is planned to avoid the obstacle area.

5. The method of claim 1, further comprising:
determining an obstacle location area in the target area based on a received user operation;
wherein the navigation route is planned to avoid the obstacle area.

6. The method of claim 5, wherein the user operation includes at least one of:
a selection operation to select one or more area graphs from a set of various area graphs,
a placement operation to place one or more selected area graphs in the target area,
a location adjustment operation to adjust a location of an area graph already placed in the target area, or
a dimension adjustment operation to adjust a dimension of an area graph already placed in the target area.

7. The method of claim 1, wherein:
the one of the boundary line sections has the intersecting relationship with the to-be-analyzed line section if a line where the to-be-analyzed line section is located intersects with the one of the boundary line sections and a line where the one of the boundary line sections is located intersects with the to-be-analyzed line section; and/or
the initial area is a polygon-shaped area obtained based on the initial corner points configured in an interactive interface; and/or
transmitting special location point information to a movable object moving along the navigation route; wherein the special location points include at least one of a return-to-base location point, a flight base location point, or an obstacle location point.

8. The method of claim 1, wherein planning the navigation route includes:
automatically generating, based on a pre-configured waypoint configuration rule, the navigation route in the target area, and obtaining navigation route data including a plurality of waypoints and locations of the waypoints.

9. The method of claim 8, further comprising:
obtaining corner point insertion data received by a client terminal, the corner point insertion data including data of a newly inserted corner point in the target area received at a user interface of the client terminal; and triggering to obtain a location of the newly inserted corner point; and/or
dividing the generated navigation route into a plurality of sub-routes; and transmitting the plurality of sub-routes to one or more movable objects.

10. A control device comprising:
a user interface configured to process interactive data; and
a processor coupled to the user interface and configured to:
determine, in response to a new corner point being added, one of initial corner points of an initial area as a connecting corner point based on locations of the initial corner points and a location of the new corner point, the new corner point and the connecting corner point forming end points of a to-be-analyzed line section, and the initial area including boundary line sections each having two adjacent ones of the initial corner points as end points;
determine whether one of the boundary line sections has an intersecting relationship with the to-be-analyzed line section;
in response to determining that none of the boundary line sections has the intersecting relationship with the to-be-analyzed line section, determine a target area including the new corner point and the initial corner points; and
plan a navigation route in the target area.

11. The control device of claim 10, wherein the processor is further configured to:
based on the locations of the initial corner points and the location of the new corner point, determine distances between the initial corner points and the new corner point; and
determine the connecting corner point from the initial corner points according to an ascending order of the distances.

12. The control device of claim 11, wherein the processor is further configured to:
in response to determining that one of the boundary line sections has the intersecting relationship with the to-be-analyzed line section, determine a new connecting corner point from remaining ones of the initial corner points except the connecting corner point according to the ascending order of the distances, the new corner point and the new connecting corner point forming end points of a new to-be-analyzed line section; and
determine whether one of the boundary line sections has an intersecting relationship with the new to-be-analyzed line section.

13. The control device of claim 10, wherein the processor is further configured to:
detect existence of an obstacle location area in the target area;
based on the obstacle location area, determine a plurality of obstacle corner points;
based on the plurality of obstacle corner points, obtain an obstacle area in the target area; and
plan the navigation route to avoid the obstacle area.

14. The control device of claim 10, wherein the processor is further configured to:
determine an obstacle location area in the target area based on a received user operation; and
plan the navigation route to avoid the obstacle area.

15. The control device of claim 14, wherein the user operation includes at least one of:
a selection operation to select one or more area graphs from a set of various area graphs,
a placement operation to place one or more selected area graphs in the target area,
a location adjustment operation to adjust a location of an area graph already placed in the target area, or
a dimension adjustment operation to adjust a dimension of an area graph already placed in the target area.

16. The control device of claim 10, wherein:
the initial area is a polygon-shaped area obtained by planning based on corner points configured in an interactive interface; and/or
the one of the boundary line sections has the intersecting relationship with the to-be-analyzed line section if a line where the to-be-analyzed line section is located intersects with the one of the boundary line sections and a line where the one of the boundary line sections is located intersects with the to-be-analyzed line section.

17. The control device of claim 10, wherein the processor is further configured to:
automatically generate, based on a pre-configured waypoint configuration rule, the navigation route in the target area, and obtain navigation route data including a plurality of waypoints and locations of the waypoints.

18. The control device of claim 17, wherein the processor is further configured to:
obtain corner point insertion data received by a client terminal, the corner point insertion data including data of a newly inserted corner point in the target area received at a user interface of the client terminal; and
trigger to obtain a location of the newly inserted corner point.

19. The control device of claim 17, wherein the processor is further configured to:
divide the generated navigation route into a plurality of sub-routes; and
transmit the plurality of sub-routes to one or more movable objects.

20. The control device of claim 10, wherein the processor is further configured to:
transmit special location point information to a movable object moving along the navigation route, the special location points including at least one of a return-to-base location point, a flight base location point, or an obstacle location point.
